(19) United States
(12) Patent Application Publication
(10) Pub. No.: US 2023/0395988 A1
(43) Pub. Date: Dec. 7, 2023

(54) ANTENNA AND METHOD OF MANUFACTURING AN ANTENNA

(71) Applicant: Nokia Shanghai Bell Co., Ltd., Shanghai (CN)

(72) Inventor: Loic ISAMBARD, Campbon (FR)

(73) Assignee: Nokia Shanghai Bell Co., Ltd., Shanghai (CN)

(21) Appl. No.: 18/318,181

(22) Filed: May 16, 2023

(30) Foreign Application Priority Data
Jun. 1, 2022 (EP) 22176810.4

(51) Int. Cl. H01Q 15/16; H01Q 1/12

(52) U.S. Cl. CPC H01Q 15/16; H01Q 1/1228

(57) ABSTRACT

In one embodiment, the antenna includes a reflector, a support plate for attaching the reflector to a structure, for example a mounting pole, a housing for a first radio device, wherein the housing is attached to the support plate, and a first supporting rod attached to the housing, wherein the first supporting rod is arranged outside of a virtual plane associated with the support plate and is configured to connect the housing to the structure.

### FIELD OF THE DISCLOSURE

Various example embodiments relate to an antenna.

Further exemplary embodiments relate to a method of manufacturing an antenna.

### BACKGROUND

Antennas may be used for transmitting and/or receiving radio frequency signals, e.g. in a microwave frequency range and/or in other frequency ranges.

External forces, e.g. due to wind or vibrations of a structure carrying an antenna may affect a mounting or alignment of the antenna. Further, attaching devices to an antenna, such as e.g. active and/or passive devices for processing radio frequency signals associated with the antenna, may increase a wind load and/or a mass of the antenna.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an antenna comprising a reflector, a support plate for attaching the reflector to a structure, for example a mounting pole, a housing for a first radio device, wherein the housing is attached to the support plate, and a first supporting rod attached to the housing, wherein the first supporting rod is arranged outside of a virtual plane associated with the support plate and is configured to connect the housing to the structure. In some embodiments, this enables to provide a particularly rigid and reliable attachment of the antenna to the structure, e.g. mounting pole. In some embodiments, an existing antenna mounting structure may e.g. be reinforced by providing the first supporting rod.

In some embodiments, the antenna may be a microwave antenna, e.g. being configured to transmit and/or receive radio frequency signals of a microwave frequency range.

In some embodiments, the antenna may be configured to transmit and/or receive radio frequency signals associated with more than one frequency band, e.g. two different frequency bands such as e.g. an E-Band characterizing a frequency band between 71 GHz and 86 GHz and a further frequency band, e.g. “Low Band”, e.g. in a frequency range of 15 to 22 GHz.

In some embodiments, the antenna may be configured to transmit and/or receive radio frequency signals associated with different polarizations, e.g. horizontal polarization and vertical polarization.

In some embodiments, a first mounting point for attaching at least one of a) a first axial end section of the first supporting rod and b) a mounting bracket for attaching the first axial end section of the first supporting rod to the housing is spaced apart from the virtual plane by a non-vanishing distance, wherein for example the distance is greater than or equal to 3 cm. In some embodiments, the distance is greater than or equal to 5 cm. In some embodiments, the distance is greater than or equal to 10 cm, e.g. 11 cm.

In some embodiments, the first supporting rod may be arranged at least substantially parallel to the virtual plane. In other words, in some embodiments, the non-vanishing distance between the first mounting point and the virtual plane may be chosen such that the first supporting rod may be arranged at least substantially parallel to the virtual plane. In some embodiments, “substantially parallel to the virtual plane” includes angular deviations from a parallel arrangement between −10 degrees and +10 degrees, e.g. between −5 degrees and +5 degrees.

In some embodiments, the reflector is attached to a first surface of the support plate, wherein the housing is attached with a proximal end section to a second surface of the support plate, which is opposite to the first surface of the support plate, and wherein the housing is attached with a distal end section to at least one of a) a first axial end section of the first supporting rod and b) a mounting bracket for attaching the first axial end section of the first supporting rod to the housing.

In some embodiments, the support plate comprises a first axial end section for attaching at least one of the reflector and the housing to the support plate and a second axial end section for connecting the support plate to the structure, wherein an intersection point of a longitudinal axis of the first supporting rod with the virtual plane is beyond the second axial end section of the support plate, for example beyond the structure, e.g. as seen from the region associated with the support plate.

In some embodiments, at least one of a) the first axial end section of the first supporting rod and b) a second axial end section of the first supporting rod for connecting the first supporting rod to the structure is arranged outside of the virtual plane.

In some embodiments, the antenna comprises at least one further, for example second, supporting rod attached to the housing, wherein the second supporting rod is also arranged outside of the virtual plane and configured to connect the housing to the structure.

In some embodiments, more than two supporting rods may also be used.

In some embodiments, one or more aspects and embodiments explained, for exemplary purposes, primarily with reference to the first supporting rod may also be applied to at least one further supporting rod, such as e.g. to the second supporting rod.

In some embodiments, the antenna comprises a first mounting bracket for attaching at least the first axial end section of the first supporting rod to the housing.

In some embodiments, the first mounting bracket comprises an L-shaped cross-section having a first arm for attaching the first mounting bracket to the housing and a second arm for attaching at least the first supporting rod to the first mounting bracket. In some embodiments, more than one supporting rod may be attached to the first mounting bracket, e.g. to the second arm of the first mounting bracket.

In some embodiments, the antenna comprises a second mounting bracket, which, for example, comprises U-shape, for attaching a or the first axial end section of the first supporting rod to the first mounting bracket.

In some embodiments, at least the first supporting rod, or, in case of two or more supporting rods, at least one of the two or more supporting rods is hollow.

In some embodiments, at least the first supporting rod comprises a through hole in a first axial end section, e.g. for receiving a screw or threaded bolt, e.g. for fastening the first supporting rod to the second mounting bracket.

In some embodiments, the antenna comprises a third mounting bracket having a, for example V-shaped, groove for receiving a section of the first supporting rod, e.g. an intermediate section arranged between the first axial end section and the second axial end section, or the second axial end section, and a, for example U-shaped, first fastening bolt for fastening the section of the first supporting rod to the third mounting bracket.

In some embodiments, the third mounting bracket has a first hole and a second hole for receiving the first fastening bolt, and a third hole and a fourth hole for attaching a fourth mounting bracket, which, for example, comprises U-shape, to the third mounting bracket.

In some embodiments, at least one of the third hole and the fourth hole is an oblong hole, for example a curved oblong hole, wherein a center distance of the third hole and the fourth hole corresponds with a distance of two holes of the fourth mounting bracket for fastening the fourth mounting bracket to the third mounting bracket.

In some embodiments, the antenna comprises a second, for example V-shaped, fastening bolt for fastening the fourth mounting bracket to the structure.

Further exemplary embodiments relate to a method of manufacturing an antenna comprising: providing a reflector, providing a support plate for attaching the reflector to a structure, for example a mounting pole, attaching a housing for a first radio device to the support plate, attaching a first supporting rod to the housing, wherein the first supporting rod is arranged outside of a virtual plane associated with the support plate and is configured to connect the housing to the structure.

In some embodiments, at least one further supporting rod, e.g. a second supporting rod, may be provided.

### BRIEF DESCRIPTION OF THE FIGURES

FIG. 1 schematically depicts a simplified top view of an antenna according to some embodiments,

FIG. 2 schematically depicts a simplified rear view of an antenna according to some embodiments,

FIG. 3 schematically depicts a simplified rear view of an antenna according to some embodiments,

FIG. 4 schematically depicts a simplified perspective view according to some embodiments,

FIG. 5 schematically depicts a simplified perspective view according to some embodiments,

FIG. 6 schematically depicts a simplified perspective view of aspects according to some embodiments,

FIG. 7 schematically depicts a simplified perspective view of aspects according to some embodiments,

FIG. 8 schematically depicts a simplified perspective view of aspects according to some embodiments,

FIG. 9 schematically depicts a simplified perspective view of aspects according to some embodiments,

FIG. 10 schematically depicts a simplified perspective view of aspects according to some embodiments,

FIG. 11 schematically depicts a simplified perspective view of aspects according to some embodiments,

FIG. 12 schematically depicts a simplified side view of aspects according to some embodiments,

FIG. 13A schematically depicts a simplified perspective view of aspects according to some embodiments,

FIG. 13B schematically depicts a simplified front view of aspects according to some embodiments,

FIG. 14 schematically depicts a simplified perspective view of aspects according to some embodiments,

FIG. 15 schematically depicts a simplified top view of aspects according to some embodiments,

FIG. 16A schematically depicts a simplified perspective view of aspects according to some embodiments,

FIG. 16B schematically depicts a simplified perspective view of aspects according to some embodiments,

FIG. 17 schematically depicts a simplified top view of aspects according to some embodiments,

FIG. 18 schematically depicts a simplified rear view of aspects according to some embodiments,

FIG. 19A schematically depicts a simplified side view of aspects according to some embodiments,

FIG. 19B schematically depicts a simplified side view of aspects according to some embodiments,

FIG. 20A schematically depicts a simplified perspective view of aspects according to some embodiments,

FIG. 20B schematically depicts a simplified perspective view of aspects according to some embodiments,

FIG. 21A schematically depicts a simplified top view of aspects according to some embodiments,

FIG. 21B schematically depicts a simplified top view of aspects according to some embodiments,

FIG. 22A schematically depicts a simplified perspective view of aspects according to some embodiments,

FIG. 22B schematically depicts a simplified perspective view of aspects according to some embodiments,

FIG. 23A schematically depicts a simplified rear view of aspects according to some embodiments,

FIG. 23B schematically depicts a simplified rear view of aspects according to some embodiments,

FIG. 24A schematically depicts a simplified perspective view of aspects according to some embodiments,

FIG. 24B schematically depicts a simplified perspective view of aspects according to some embodiments,

FIG. 25A schematically depicts a simplified perspective view of aspects according to some embodiments,

FIG. 25B schematically depicts a simplified perspective view of aspects according to some embodiments, and

FIG. 26 schematically depicts a simplified flow chart according to some embodiments.

### DESCRIPTION OF SOME EXEMPLARY EMBODIMENTS

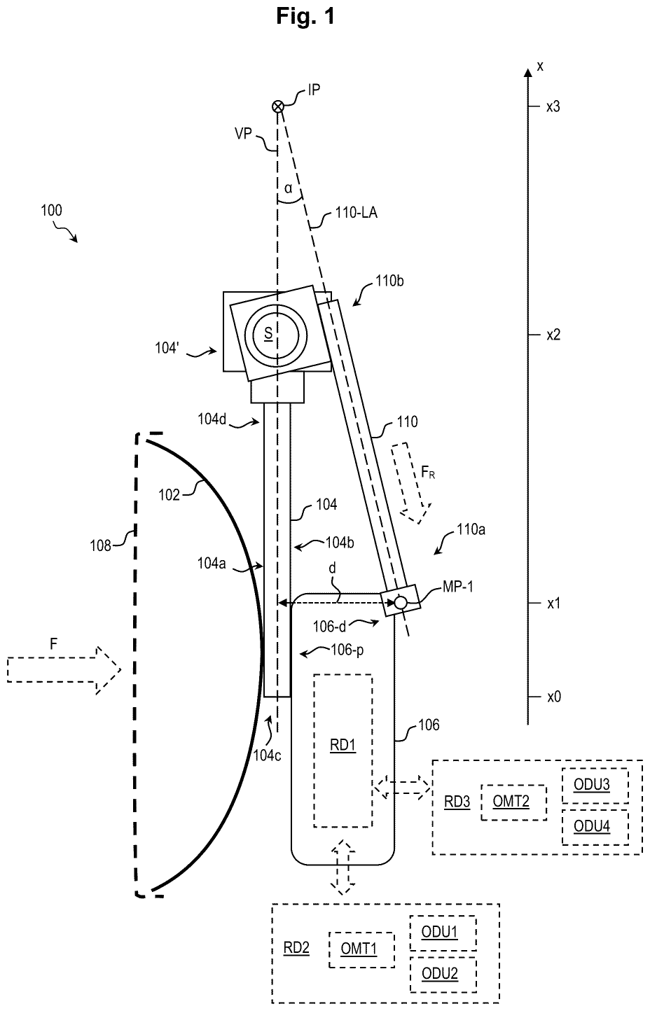

Some exemplary embodiments, see for example FIG. 1, relate to an antenna 100 comprising a reflector 102, a support plate 104 for attaching the reflector 102 to a structure S, for example a mounting pole, e.g. circular mounting pole, a housing 106 for a first radio device RD1, wherein the housing 106 is attached to the support plate 104, and a first supporting rod 110 attached to the housing 106, wherein the first supporting rod 110 is arranged outside of a virtual plane VP associated with, e.g. defined by, the support plate 104 and is configured to connect (e.g., mechanically) the housing 106 to the structure S. In other words, the first supporting rod 110 implements an additional mechanical connection to the structure, i.e. in addition to the support plate 104, whereby, in some embodiments, a stability of the configuration 100 may be increased. Optionally, a radome 108 may be provided, e.g. to cover the reflector 102.

In some embodiments, the provisioning of the first supporting rod 110 enables to provide a particularly rigid and reliable attachment of the antenna 100 to the structure S, e.g. mounting pole. In some embodiments, an existing antenna mounting structure may e.g. be reinforced by providing the first supporting rod 110, or generally, at least one supporting rod according to the embodiments.

In some embodiments, the antenna 100 may be a microwave antenna, e.g. being configured to transmit and/or receive radio frequency signals of a microwave frequency range.

In some embodiments, the antenna 100 may be configured to transmit and/or receive radio frequency signals associated with more than one frequency band, e.g. two different frequency bands such as e.g. an E-Band characterizing a frequency band between 71 GHz and 86 GHz and a further frequency band, e.g. “Low Band”, e.g. in a frequency range of 15 to 22 GHz.

In some embodiments, the antenna 100 may be configured to transmit and/or receive radio frequency signals associated with different polarizations, e.g. horizontal polarization and vertical polarization.

As an example, the first radio device RD1 may be configured to couple at least one further radio device RD2, RD3 with at least one further component of the antenna, e.g. with the reflector 102. In some embodiments, the further radio devices RD2, RD3 may e.g. comprise one orthomode-transducer (OMT) and e.g. two so-called outdoor units (ODU). In some embodiments, the outdoor units are configured to process radio frequency signals to be transmitted and/or received by the antenna 100, wherein a specific outdoor unit may e.g. be associated with a specific polarization.

As an example, in some embodiments, the radio device RD2 may comprise a first outdoor unit ODU1 associated with a first frequency range and a first, e.g. horizontal, polarization, a second outdoor unit ODU2 associated with the first frequency range and a second, e.g. vertical, polarization, and a first orthomode-transducer OMT1 for coupling the outdoor units ODU1, ODU2 with the reflector 102, e.g. via the first radio device RD1.

Similarly, in some embodiments, the radio device RD3 may comprise a third outdoor unit ODU3 associated with a second frequency range and a first, e.g. horizontal, polarization, a fourth outdoor unit ODU4 associated with the second frequency range and a second, e.g. vertical, polarization, and a second orthomode-transducer OMT2 for coupling the outdoor units ODU3, ODU4 with the reflector 102, e.g. via the first radio device RD1.

In some embodiments, the radio devices RD2, RD3 may add substantial mass and/or wind load to the antenna 100, so that the first supporting rod 110, in some embodiments, may be especially beneficial to ensure a stable mounting of the antenna 100 to the structure S.

In some embodiments, a first mounting point MP-1 for attaching at least one of a) a first axial end section 110a of the first supporting rod 110 and b) a mounting bracket 130 (see FIG. 3, for example) for attaching the first axial end section 110a of the first supporting rod 110 to the housing 106 is spaced apart from the virtual plane VP by a non-vanishing distance d, wherein for example the distance d is greater than or equal to 3 cm. In some embodiments, the distance d is greater than or equal to 5 cm.

In some embodiments, the distance d is greater than or equal to 10 cm, e.g. 11 cm.

In some embodiments, the first supporting rod 110 may be arranged at least substantially parallel (not shown) to the virtual plane VP. In other words, in some embodiments, the non-vanishing distance d between the first mounting point MP-1 and the virtual plane VP may be chosen such that the first supporting rod 110 may be arranged at least substantially parallel to the virtual plane VP. In some embodiments, “substantially parallel to the virtual plane” includes angular deviations from a parallel arrangement between −10 degrees and +10 degrees, e.g. between −5 degrees and +5 degrees.

In some embodiments, the reflector 102 is attached to a first surface 104a of the support plate 104, wherein the housing 106 is attached with a proximal end section 106-p to a second surface 104b of the support plate 104, which is opposite to the first surface 104a of the support plate 104, and wherein the housing 106 is attached with a distal end section 106-d to at least one of a) the first axial end section 110a of the first supporting rod 110 and b) a mounting bracket 130 (FIG. 3) for attaching the first axial end section 110a of the first supporting rod 110 to the housing 106.

In some embodiments, FIG. 1, the support plate 104 comprises a first axial end section 104c, e.g. at the coordinate x0 of the vertical coordinate axis x of FIG. 1, for attaching at least one of the reflector 102 and the housing 106 to the support plate 104 and a second axial end section 104d, e.g. at the coordinate x2, for connecting the support plate 104 to the structure S, e.g. via fastening means 104′ as known by those skilled in the art, wherein an intersection point IP of a longitudinal axis 110-LA of the first supporting rod 110 with the virtual plane VP, see the coordinate x3, is beyond the second axial end section 104d of the support plate 104 (e.g., x3>x2), for example beyond the structure S, e.g. as seen from the region associated with the support plate 104 (e.g., an interval between x0 and about x2).

In some embodiments, at least one of a) the first axial end section 110a of the first supporting rod 110 and b) a second axial end section 110b of the first supporting rod 110 for connecting the first supporting rod 110 to the structure S is arranged outside of the virtual plane VP.

In some embodiments, both axial end sections 110a, 110b of the first supporting rod 110 are arranged outside of the virtual plane VP, which, in some embodiments, may enable a particularly efficient reinforcement of the antenna mounting structure of the antenna 100.

In some embodiments, an angle α between the longitudinal axis 110-LA of the first supporting rod 110 and the virtual plane VP is zero (not shown), i.e. the longitudinal axis 110-LA of the first supporting rod 110 and the virtual plane VP are parallel to each other.

In some embodiments, FIG. 1, the angle α between the longitudinal axis 110-LA of the first supporting rod 110 and the virtual plane VP is greater than zero, e.g. positive.

As an example, an external force F, e.g. wind force, may be applied to the antenna 100, causing a moment (not shown in FIG. 1), e.g. around a center axis of the structure S. In some embodiments, the first supporting rod 110 may effect a resisting force F_{R} in an axial direction, e.g. along its longitudinal axis 110-LA, and, for example, an associated resisting moment. In some embodiments, this may contribute to a significantly increased rigidity, e.g. as compared to a conventional configuration without a supporting rod 110 according to the principle of the embodiments. Advantageously, the first supporting rod 110 may provide the resisting force F_{R}, as an axial force, which is particularly efficient, e.g. as compared to a bending force as may be experienced by the support plate 104.

In some embodiments, the first mounting point MP-1 is arranged at a coordinate x1>x0, which saves material and thus weight for the first supporting rod 110, but which also enables to provide the axial resisting force F_{R}, e.g. in case of the external force F.

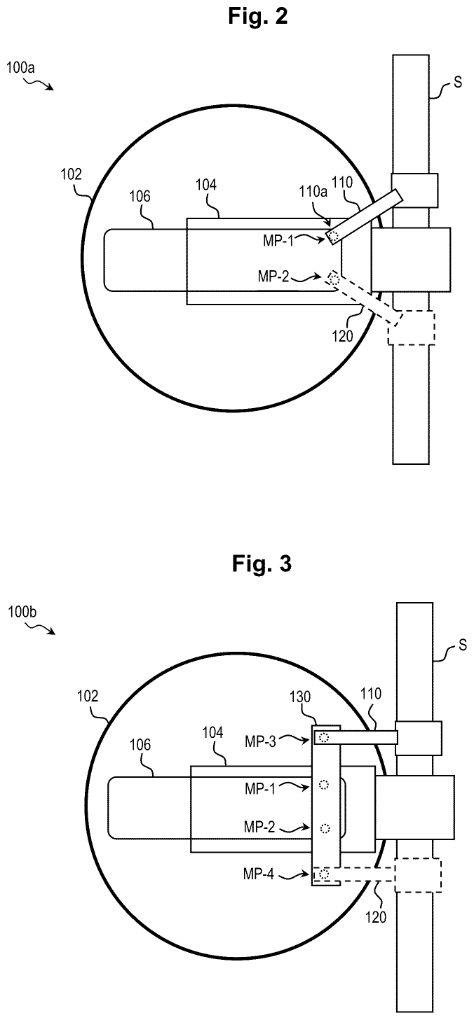

In some embodiments, FIG. 2, the antenna 100a comprises at least one further, for example second, supporting rod 120 attached to the housing 106, wherein the second supporting rod 120 is also arranged outside of the virtual plane VP (FIG. 1) and configured to connect the housing 106 to the structure S.

As can be seen from FIG. 2, in some embodiments, a second mounting point MP-2, e.g. similar to the first mounting point MP-1 for the first supporting rod 110, may be provided, e.g. for attaching a first axial end section of the second supporting rod 120 to the housing 106.

While in FIG. 2 the optional, second supporting rod 120 is provided below the support plate 104, in some embodiments, which have a single, i.e. the first, supporting rod 110, the first supporting rod 110 may also be provided below the support plate 104 (not shown), e.g. similar to the second supporting rod 120 of FIG. 2.

In some embodiments, more than two supporting rods 110, 120 may also be used (not shown).

In some embodiments, one or more aspects and embodiments explained, for exemplary purposes, primarily with reference to the first supporting rod 110 may also be applied to at least one further supporting rod, such as e.g. to the second supporting rod 120.

In some embodiments, FIG. 3, the antenna 100b comprises a first mounting bracket 130 for attaching at least the first axial end section 110a (FIG. 1) of the first supporting rod 110 to the housing 106. In other words, the first axial end section 110a (FIG. 1) of the first supporting rod 110 may be attached to the first mounting bracket 130, and the first mounting bracket 130 may be attached to the housing 106. In some embodiments, similar observations apply to an optional further, e.g. second, supporting rod 120.

Presently, as an example, the first mounting bracket 130 is attached to the housing 106 using two mounting points MP-1, MP-2, whereas a first axial end section of the first supporting rod 110 is attached to the first mounting bracket 130 using a third mounting point MP-3 and a second axial end section of the optional second supporting rod 120 is attached to the first mounting bracket 130 using a fourth mounting point MP-4.

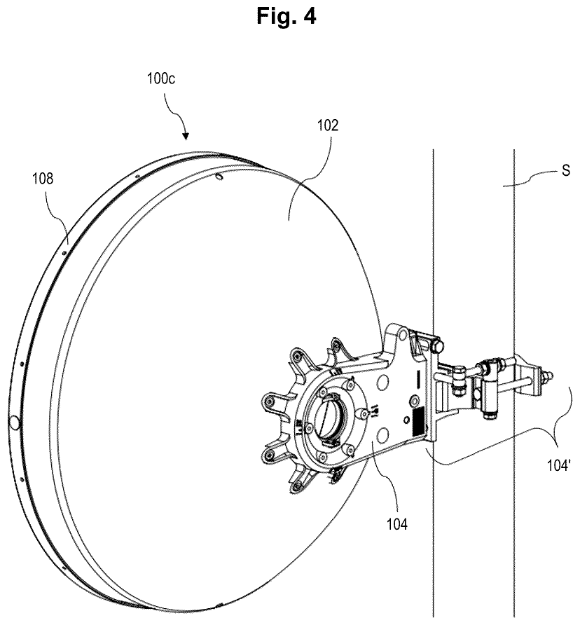

FIG. 4 schematically depicts a simplified perspective view of the antenna 100c according to some embodiments in a state where the housing 106 is not attached to the support plate 104. As already mentioned above, fastening means 104′ may be provided to connect, e.g. fasten, the support plate 104 to the structure S.

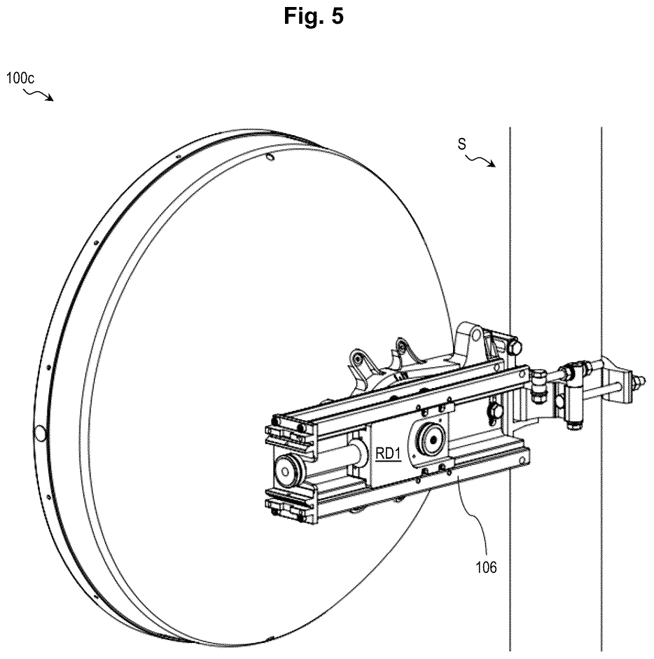

FIG. 5 schematically depicts a simplified perspective view of the antenna 100c of FIG. 4 in a state with the housing 106 attached to the support plate 104. Also depicted is the first radio device RD1, as exemplarily explained above with respect to FIG. 1.

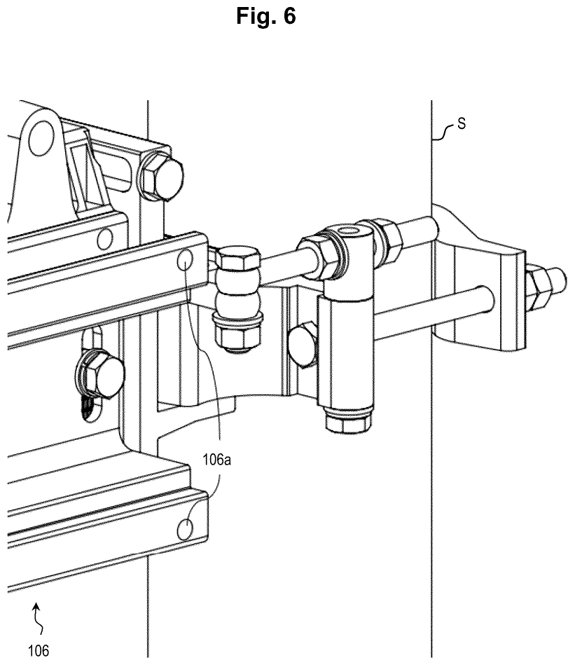

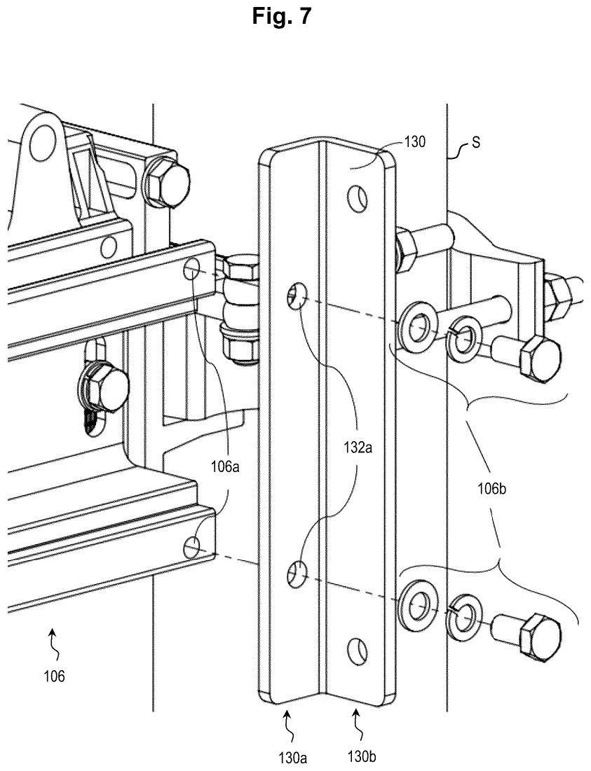

FIG. 6 schematically depicts a simplified perspective view of detail aspects according to some embodiments. In some embodiments, the housing 106 may provide holes 106a, e.g. for implementing the mounting points MP-1, MP-2 of FIG. 3, e.g. for directly attaching at least one supporting rod 110, 120 to the housing or for attaching the first mounting bracket 130 to the housing 106, see FIG. 7. In some embodiments, the holes 106a may be threaded holes.

In some embodiments, as exemplarily depicted by FIG. 7, the first mounting bracket 130 comprises an L-shaped cross-section having a first arm 130a for attaching the first mounting bracket 130 to the housing 106 and a second arm 130b for attaching at least the first supporting rod 110 (FIG. 1, 3) to the first mounting bracket 130. In some embodiments, more than one supporting rod 110, 120 (FIG. 3) may be attached to the first mounting bracket, e.g. to the second arm 130b of the first mounting bracket 130.

In some embodiments, FIG. 7, the threaded holes 106a are used to assemble the first mounting bracket 130 with the housing 106. In some embodiments, two sets of screws 106b (optionally with one or more washers, e.g. spring washers) may be provided, which are tightened through holes 132a and threads 100a. In some embodiments, the first mounting bracket 130 can have another shape than the exemplarily depicted L-shape. In some embodiments, the first mounting bracket 130 can be it could be a casting part.

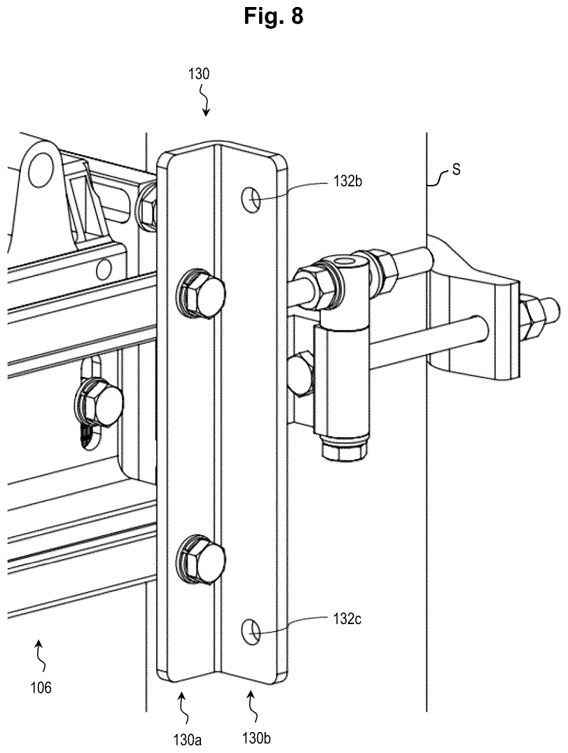

FIG. 8 depicts the configuration 106, 130 of FIG. 7 in an assembled state. In some embodiments, the hole 132b of the second arm 130b can be used for implementing the third mounting point MP-3 of FIG. 3. In some embodiments, the hole 132c of the second arm 130b can be used for implementing the fourth mounting point MP-4 of FIG. 3.

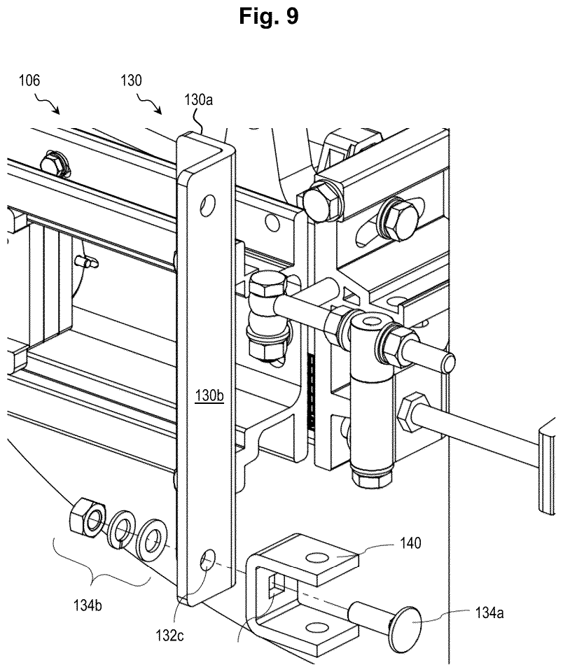

In some embodiments, FIG. 9, the antenna comprises a second mounting bracket 140, which, for example, comprises U-shape, for attaching the first axial end section 110a (FIG. 1) of the first supporting rod 110 to the first mounting bracket 130.

Note that FIG. 9 refers to an exemplary configuration where the first supporting rod 110 (FIG. 1) is attached to the fourth mounting point MP-4 (FIG. 3) implemented by the hole 132c of FIG. 9. In some embodiments, an optional second supporting rod 120 (not shown in FIG. 9) may e.g. be attached to the third hole 132b.

In the following, further details related to attachment of the first supporting rod 110 to the first mounting bracket 130 are explained. In some embodiments, the associated principles may, without loss of generality, be applied to the attachment of at least one further, e.g. second, supporting rod to the first mounting bracket 130.

In some embodiments, the second mounting bracket 140 may be fixed to the hole 132c with a bolt, e.g. threaded bolt, e.g. mushroom head square neck bolt 134a and nut 134b (optionally with one or more washers, e.g. spring washers).

In some embodiments, other fastening systems may also be used. In some embodiments, the mushroom head square neck bolt 134a has the advantage that e.g. only one wrench is needed to fasten the sub-assembly 132c, 134a, 134b, 140.

In some embodiments, the second mounting bracket 140 can rotate around the axis of hole 132c, e.g. before the tightening of the nut 134b. In some embodiments, this rotatability enables to keep one degree of freedom which may, in some embodiments, be beneficial, e.g. for an installation of the antenna.

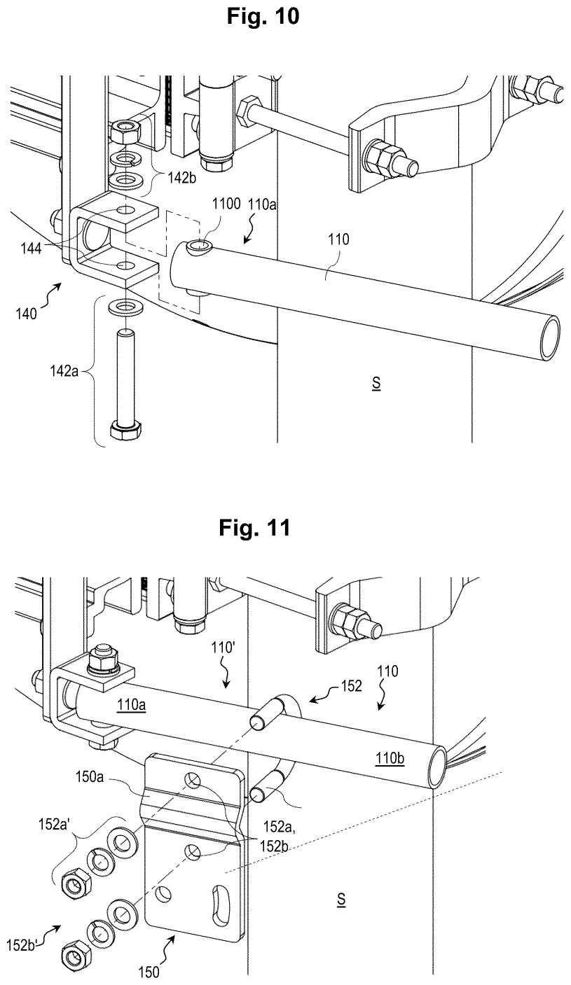

In some embodiments, FIG. 10, at least the first supporting rod 110, or, in case of two or more supporting rods, at least one of the two or more supporting rods, is hollow.

In some embodiments, at least the first supporting rod 110 comprises a through hole 1100 in a first axial end section 110a, e.g. for receiving a screw or threaded bolt 142a, e.g. for fastening the first supporting rod to the second mounting bracket, e.g. with a nut 142b and optional (spring) washer(s).

In some embodiments, a rotation of the first supporting rod 110 around an axis associated with the holes 144 is also possible, e.g. for an installation of the antenna.

In some embodiments, FIG. 11, the antenna comprises a third mounting bracket 150 having a, for example V-shaped, groove 150a for receiving a section 110′ of the first supporting rod 110, e.g. an intermediate section arranged between the first axial end section 110a and the second axial end section 110b, or the second axial end section 110b, and a, for example U-shaped, first fastening bolt 152 for fastening the section 110′ of the first supporting rod 110 to the third mounting bracket 150.

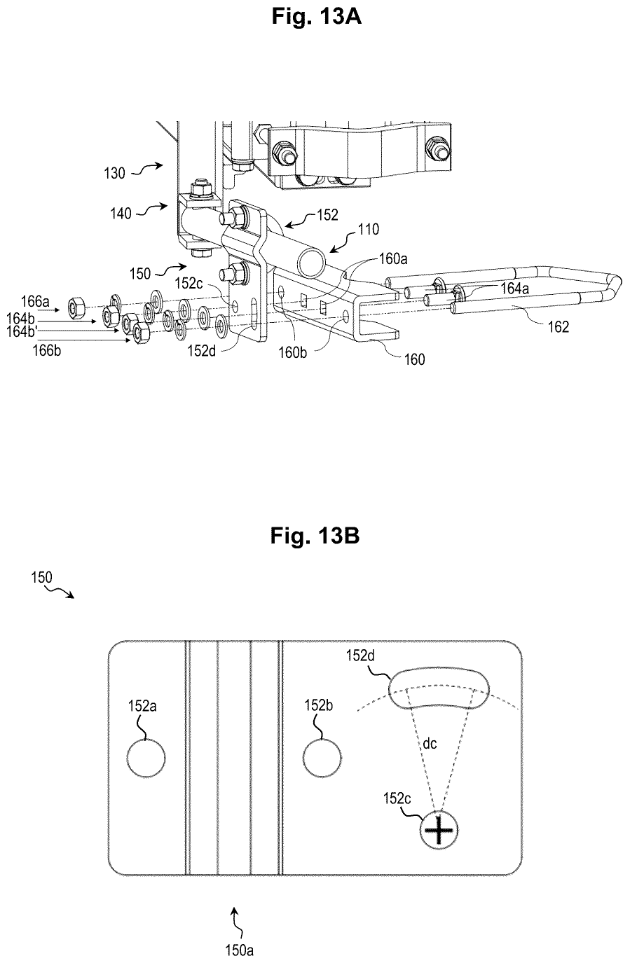

In some embodiments, see also FIG. 13B, the third mounting bracket 150 has a first hole 152a and a second hole 152b for receiving the first fastening bolt 152 (FIG. 11), and a third hole 152c and a fourth hole 152d for attaching a fourth mounting bracket 160, see FIG. 13A, which, for example, comprises U-shape, to the third mounting bracket 150.

In some embodiments, FIG. 13B, at least one of the third hole 152c and the fourth hole 152d is an oblong hole, for example a curved oblong hole 152d, wherein a center distance dc of the third hole 152c and the fourth hole 152d corresponds with a distance of two holes 160a (FIG. 13A) of the fourth mounting bracket 160 for fastening the fourth mounting bracket 160 to the third mounting bracket 150.

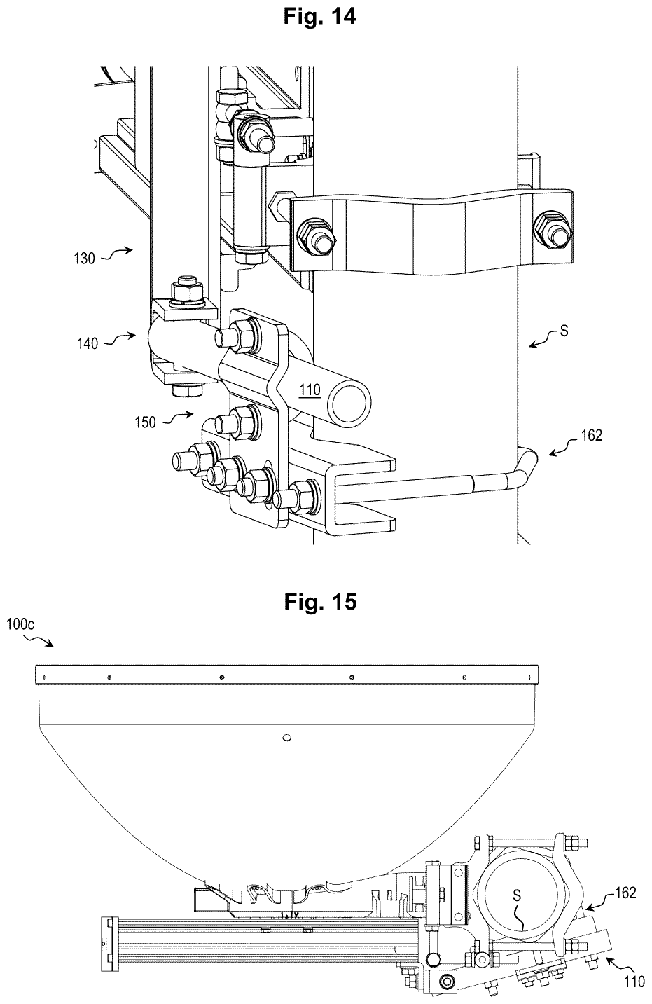

In some embodiments, FIG. 13A, the antenna comprises a second, for example V-shaped, fastening bolt 162 for fastening the fourth mounting bracket 160 to the structure S, see FIG. 14.

In some embodiments, FIG. 11, the first fastening bolt 152 may be fixed on the third mounting bracket 150 through the holes 152a, 152b, e.g. using nuts 152a′, 152b′ (and optional washers and/or spring washers).

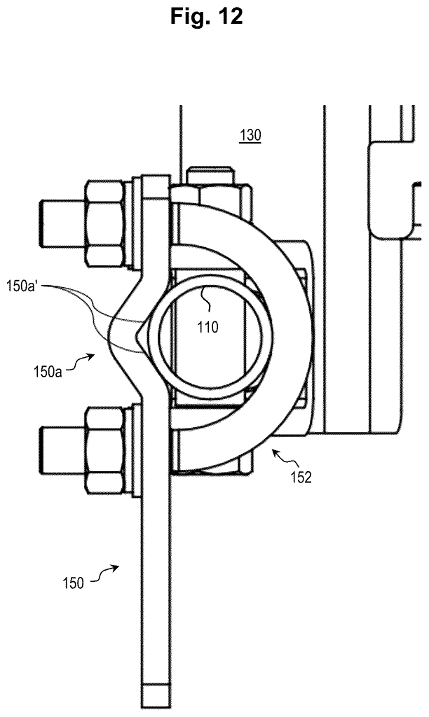

As already mentioned, in some embodiments, see FIG. 12, the third mounting bracket 150 has a V-shaped groove 150a, and the first supporting rod 110 is therefore in contact with both surfaces 150a′ so that the third mounting bracket 150 can e.g. only rotate around the longitudinal axis 110-LA (FIG. 1) of the first supporting rod 110. In this regard, for some embodiments, a circular first supporting rod 110 may be used.

In some embodiments, another shape may be used for the first supporting rod 110. In some embodiments, when using a non-circular first supporting rod 110, the design of the third mounting bracket 150 may be modified to allow a rotation around the axis of the (non-circular) supporting rod.

FIG. 13A schematically depicts further aspects of an assembly according to some embodiments. The fourth mounting bracket 160 is fixed on the third mounting bracket 150, e.g. with two mushroom head square neck bolts 164a. In some embodiments, one of the mushroom head square neck bolts 164a protrudes through one of the holes 160a and the circular hole 152c and is fastened with nut 164b, the other one of the mushroom head square neck bolts 164a protrudes through the other one of the holes 160a and the oblong curved hole 152d and is fastened with nut 164b′.

In some embodiments, FIG. 13B, a center of curvature of the curved oblong hole 152d is the hole 152c, which provides another degree of freedom, e.g. for antenna installation.

In some embodiments, FIG. 14, the first supporting rod 110 is fixed to the structure S using the second fastening bolt 162, which is e.g. fastened to the fourth mounting bracket 160 through holes 160b (FIG. 13A), e.g. using nuts 166a, 166b (and optional washers and/or spring washers).

In some embodiments, the structure or mounting pole S is circular, and hence a rotation of the second fastening bolt 162 and the fourth mounting bracket 160 is allowed during installation, providing another degree of freedom.

FIG. 14 schematically depicts a perspective view the first supporting rod 110 in its mounted state according to some embodiments, and FIG. 15 schematically depicts a top view of the first supporting rod 110 in its mounted state according to some embodiments.

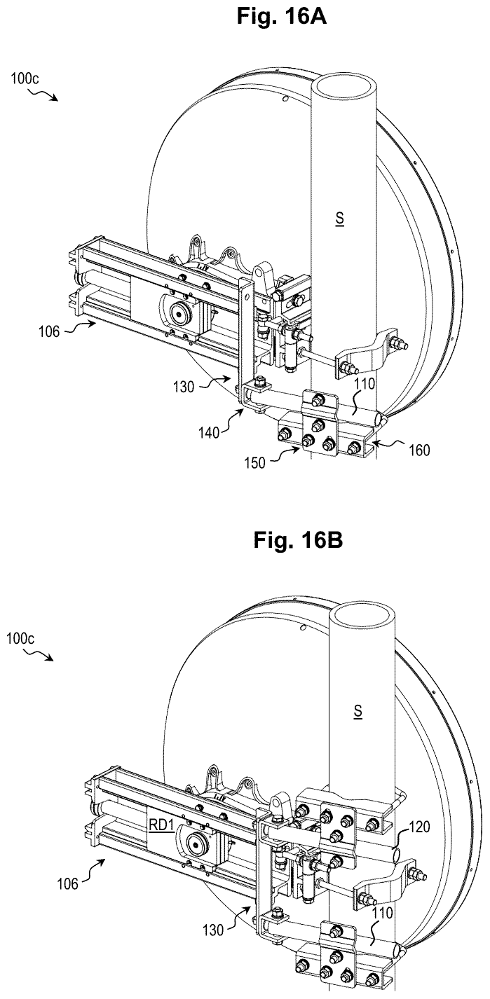

FIG. 16A, 16B schematically depict further embodiments, wherein FIG. 16A depicts the antenna 100c having one, i.e. the first, supporting rod 110, whereas FIG. 16B depicts a configuration of the antenna 100c with two supporting rods 110, 120 mounted.

In some embodiments, the “top”, i.e. second, supporting rod 120 may use or reuse same or similar parts 140, 150, 160, and the assembly of both supporting rods 110, 120 may be symmetrical.

In some embodiments, one difference may be that the third mounting bracket 150 for the supporting rods 110, 120 are turned by 180°.

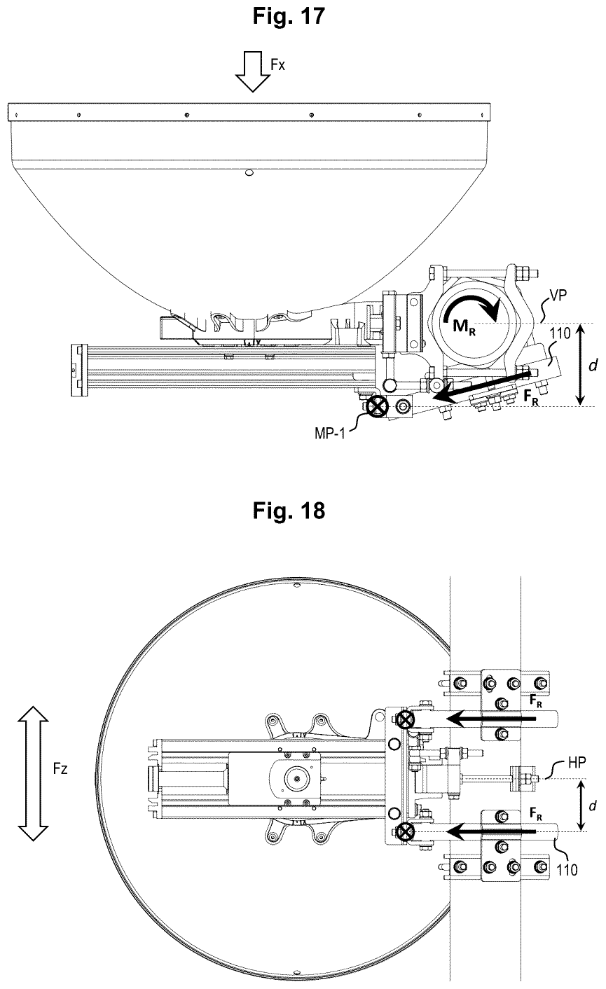

FIG. 17 schematically presents how an exemplary technical implementation according to some embodiments may help improve a mechanical stability of the antenna. When a wind or a dynamic loading Fx is acting, exemplary embodiments provide a resisting moment MR around the mounting pole S and a resisting force FR, e.g. axially, through the first supporting rod 110.

In some embodiments, the resisting moment MR prevents the antenna from slipping around the mounting pole, which may e.g. provide more security regarding a survival wind speed.

In some embodiments, the resisting force FR may help to, e.g. significantly, limit a displacement of a “reference point”, e.g. characterized by the first mounting point MP-1, and by extension of the complete antenna.

Indeed, as the resisting moment MR prevents antenna rotation around the mounting pole in some embodiments, one, e.g. only, possible displacement of the “reference point” MP-1 may e.g. be due to an elastic deformation of components of the antenna, which in some embodiments is limited due to the global stiffness of the structure when equipped with the first supporting rod 110.

In some embodiments, as a result, the elastic deformation of the antenna, e.g. under horizontal loading F, may be decreased so that e.g. an operational wind speed is improved, and the dynamic behavior may also be improved with a better stiffness.

FIG. 18 schematically depicts exemplary aspects illustrating how some embodiments enable the antenna to withstand vertical loading Fz along a Z-axis. Since in some embodiments, the first supporting rod 110 is arranged outside of a horizontal plane HP of the antenna, it provides an additional fixed point that prevents the antenna from elastic deformation in the vertical plane. In some embodiments, this contributes to reinforcing the stiffness of the antenna so that, under dynamic load on Z-axis, the level of stress in the components of the antenna is reduced.

As a result, exemplary embodiments enable to e.g. reuse a basic structure of e.g. conventional, e.g. single band, antennas, e.g. without a change on parts shared with the antenna according to the embodiments.

In the following, exemplary aspects of the kinematic of the pointing of the antenna according to some embodiments are explained. In some embodiments, there are three setups to consider: elevation, azimuth and polarization. In some embodiments, azimuth and elevation may e.g. be adjusted with a mount assembly and may e.g. be used to align the antenna with another antenna for exchanging radio frequency signals. In some embodiments, the polarization is associated with a rotation of the first radio device RD1 in relation to the antenna, which may e.g. be used to align a polarization.

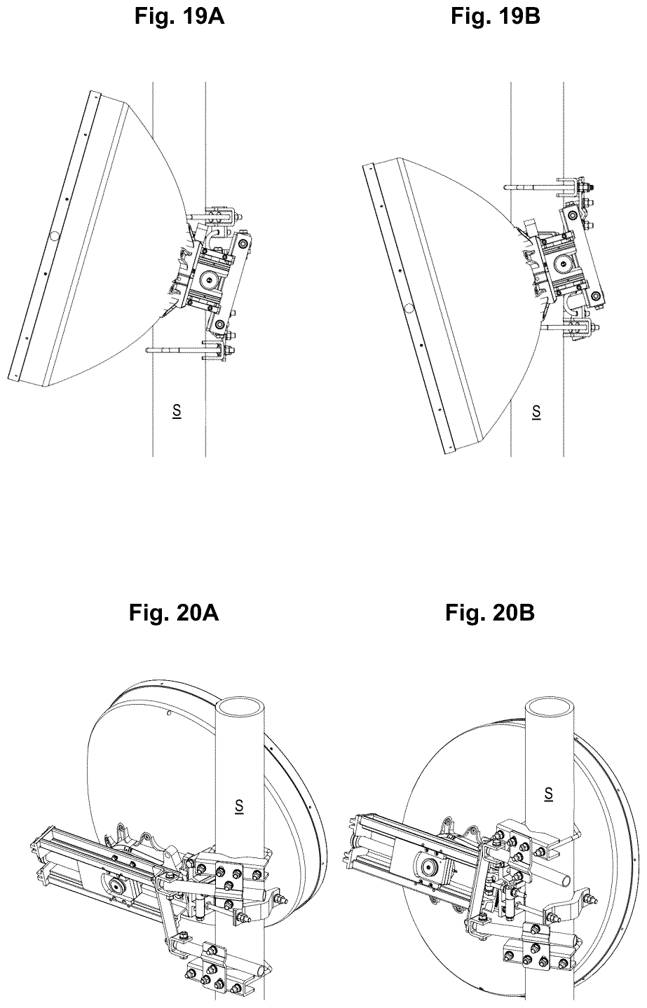

FIGS. 19A, 19B and 20A, 20B exemplarily show an elevation adjustment, e.g. ranging over an exemplary angular range of ±150.

FIG. 20A, 20B exemplarily indicate a kinematic of the supporting rods 110, 120, e.g. between both extreme elevation positions as also indicated by FIG. 19A, 19B.

In some embodiments, it can be noted that:
the second mounting bracket 140 (see also FIG. 9) can rotate in relation to the first mounting bracket 130 around the axis of the hole 132c,
the first supporting rod 110 can rotate in relation to the second mounting bracket 140 around the axis of the holes 144,
the first supporting rod 110 can rotate in relation to the third mounting bracket 150, e.g. between the V-shape, see surfaces 150a′ of FIG. 12 and the first fastening bolt 152, or, in other words, the third mounting bracket 150 with the first fastening bolt 152 can rotate in relation to the first supporting rod 110,
the first supporting rod 110 can perform a translation through the third mounting bracket 150 (FIG. 11) and the first fastening bolt 152,
the fourth mounting bracket 160 (FIG. 13A) and the second fastening bolt 162 can rotate around the mounting pole S (FIG. 14),
the fourth mounting bracket 160 and the second fastening bolt 162 can perform a translation along the mounting pole S.

As a result, in some embodiments, FIG. 20A, 20B, the first supporting rod 110 may remain e.g. in a horizontal position, e.g. independent of the elevation angle of the reflector 102.

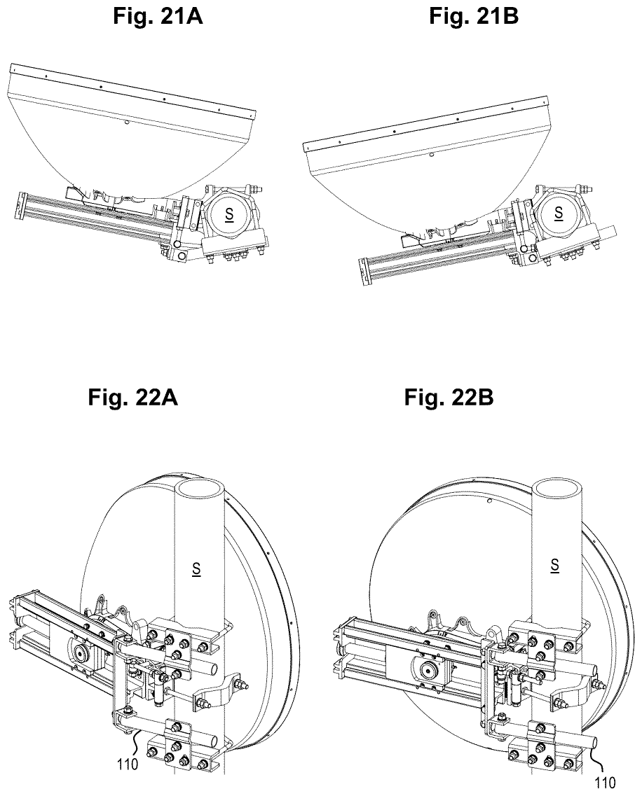

FIG. 21A, 21B exemplarily show an azimuth adjustment, e.g. ranging over an exemplary angular range of ±15°.

FIG. 22A, 22B exemplarily illustrate the kinematic of the first supporting rod 110 between both extreme azimuth positions. In some embodiments, it can be noted that:
the first supporting rod 110 can rotate in relation to the second mounting bracket 140 (FIG. 9) around the axis of the holes 144,
the first supporting rod 110 can perform a translation through the third mounting bracket 150 and the first fastening bolt 152,
the fourth mounting bracket 160 and the second fastening bolt 162 can rotate around the mounting pole S.

As a result, in some embodiments, the first supporting rod 110 may e.g. remain in a horizontal position, e.g. independent of the azimuth angle.

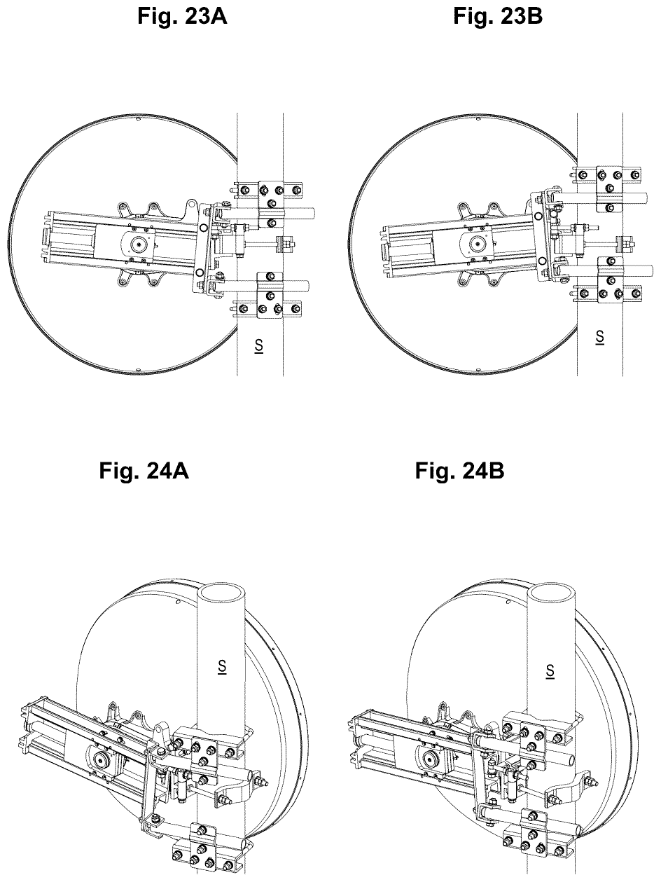

FIG. 23A, 23B exemplarily show a polarization adjustment, e.g. ranging over an exemplary angular range of ±5°.

FIG. 24A, 24B illustrate the kinematic of the first supporting rod 110 between both exemplary extreme polarization positions as depicted by FIG. 23A, 23B. In some embodiments, it can be noted that:
the second mounting bracket 140 can rotate in relation to the first mounting bracket 130 around the axis of the hole 132c (FIG. 9),
the first supporting rod 110 can rotate in relation to the second mounting bracket 140 around the axis of holes 144 (FIG. 10),
the first supporting rod 110 can rotate in relation to the third mounting bracket 150, e.g. between the V-shape, see surfaces 150a′ of FIG. 12 and the first fastening bolt 152, or, in other words, the third mounting bracket 150 with the first fastening bolt 152 can rotate in relation to the first supporting rod 110,
the first supporting rod 110 can perform a translation through the third mounting bracket 150 and the first fastening bolt 152,
the fourth mounting bracket 160 and the second fastening bolt 162 can rotate, at least to some degree, around the mounting pole S,
the fourth mounting bracket 160 and the second fastening bolt 162 can perform a translation along the mounting pole S.

As a result, in some embodiments, the first supporting rod 110 may e.g. remain in a horizontal position, e.g. independent of the polarization angle.

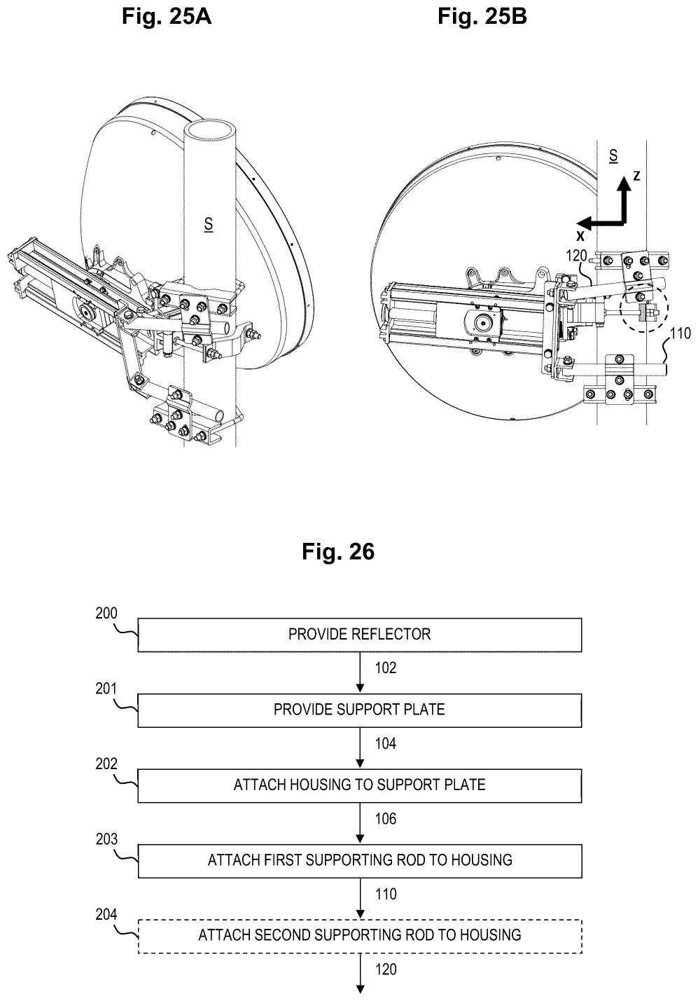

In some embodiments, as e.g. pointed out with reference to FIG. 13B, the third mounting bracket 150 has one circular hole 152c and one oblong curved hole 152d, which e.g. enables the first supporting rod 110 to be, at least slightly, tilted in a vertical plane, for example meaning that the first supporting rod 110 in some embodiments can be in an “almost horizontal” position, which, in some embodiments, can be beneficial with respect to the following aspects: a) it may ease an installation of the supporting rod 110 in the field, it may add a degree of freedom that may e.g. provide more flexibility for an installer, b) it may e.g. be used when some or all pointing adjustments are in their respective extreme positions, as exemplarily depicted by FIG. 25A, 25B.

In some embodiments, a length of the first mounting bracket 130 may be increased, which, however, may decrease a stiffness of the antenna. In some embodiments, the longer the first mounting bracket 130 is, the lower the stiffness of the antenna may be, as there is added flexibility. Thus, in some embodiment, a compromise may be to have a slight tilt of the first supporting rod 110, e.g. for some cases. Moreover, in some embodiments, the allowed tilt of the first supporting rod 110 may be limited and does not decrease the mechanical behaviour of the antenna.

As mentioned above, FIG. 25A, 25B illustrate an exemplary extreme position of the antenna, e.g. when the azimuth is +10°, the elevation is +150 and the polarization is +5°. In that case, the optional second supporting rod 120 may e.g. have a small angular position, e.g. deviation from a horizontal orientation, e.g. to avoid a potential clearance issue with the fastening means 104′ (FIG. 1), also see the dashed circle of FIG. 25B. In some embodiments, however, the first supporting rod 110 remains horizontal.

In some embodiments, e.g. when the extreme position of the antenna is the opposite, the first supporting rod 110 may e.g. have a small angular position, e.g. deviation from a horizontal orientation, e.g. to avoid a potential clearance issue with the fastening means 104′ (not shown).

Further exemplary embodiments, FIG. 26, relate to a method of manufacturing an antenna comprising: providing 200 a reflector 102, providing 201 a support plate 104 for attaching the reflector 102 to a structure S, for example a mounting pole, attaching 202 a housing 106 for a first radio device RD1 to the support plate 104, attaching 203 a first supporting rod 110 to the housing 106, wherein the first supporting rod 110 is arranged outside of a virtual plane VP (FIG. 1) associated with the support plate 104 and is configured to connect the housing 106 to the structure S.

In some embodiments, at least one further supporting rod, e.g. a second supporting rod 120, may be provided, and may e.g. be attached to the housing 106.

Further exemplary embodiments relate to an antenna 100, 100a, 100b, 100c comprising a reflector 102, a support plate 104 for attaching the reflector 102 to a structure S, for example a mounting pole, a housing 106 for a first radio device RD1, wherein the housing 106 is attached to the support plate 104, and supporting means 110, 120 attached to the housing 106, wherein the supporting means 110, 120 are arranged outside of a virtual plane VP associated with the support plate 104 and are configured to connect the housing 106 to the structure S.

In some embodiments, the supporting means 110, 120 may e.g. comprise at least one supporting rod 110, 120.

1. An antenna comprising a reflector, a support plate for attaching the reflector to a structure, for example a mounting pole, a housing for a first radio device, wherein the housing is attached to the support plate, and a first supporting rod attached to the housing, wherein the first supporting rod is arranged outside of a virtual plane associated with the support plate and is configured to connect the housing to the structure.

2. The antenna of claim 1, wherein a first mounting point for attaching at least one of a) a first axial end section of the first supporting rod and b) a mounting bracket for attaching the first axial end section of the first supporting rod to the housing is spaced apart from the virtual plane by a non-vanishing distance, wherein for example the distance is greater than or equal to 3 cm.

3. The antenna of claim 1, wherein the reflector is attached to a first surface of the support plate, wherein the housing is attached with a proximal end section to a second surface of the support plate, which is opposite to the first surface of the support plate, and wherein the housing is attached with a distal end section to at least one of a) a first axial end section of the first supporting rod and b) a mounting bracket for attaching the first axial end section of the first supporting rod to the housing.

4. The antenna of claim 1, wherein the support plate comprises a first axial end section for attaching at least one of the reflector and the housing to the support plate and a second axial end section for connecting the support plate to the structure, wherein an intersection point of a longitudinal axis of the first supporting rod with the virtual plane is beyond the second axial end section of the support plate, for example beyond the structure.

5. The antenna of claim 2, wherein at least one of a) the first axial end section of the first supporting rod and b) a second axial end section of the first supporting rod for connecting the first supporting rod to the structure is arranged outside of the virtual plane.

6. The antenna of claim 1, comprising at least one further, for example second, supporting rod attached to the housing, wherein the second supporting rod is also arranged outside of the virtual plane and configured to connect the housing to the structure.

7. The antenna of claim 1, comprising a first mounting bracket for attaching at least the first axial end section of the first supporting rod to the housing.

8. The antenna of claim 7, wherein the first mounting bracket comprises an L-shaped cross-section having a first arm for attaching the first mounting bracket to the housing and a second arm for attaching at least the first supporting rod to the first mounting bracket.

9. The antenna of claim 7, comprising a second mounting bracket, which, for example, comprises U-shape, for attaching a or the first axial end section of the first supporting rod to the first mounting bracket.

10. The antenna of claim 1, wherein at least the first supporting rod, or, in case of two or more supporting rods, at least one of the two or more supporting rods is hollow.

11. The antenna of claim 1, wherein at least the first supporting rod comprises a through hole in a first axial end section.

12. The antenna of claim 9, comprising a third mounting bracket having a, for example V-shaped, groove for receiving a section of the first supporting rod, and a, for example U-shaped, first fastening bolt for fastening the section of the first supporting rod to the third mounting bracket.

13. The antenna of claim 12, wherein the third mounting bracket has a first hole and a second hole for receiving the first fastening bolt, and a third hole and a fourth hole for attaching a fourth mounting bracket, which, for example, comprises U-shape, to the third mounting bracket.

14. The antenna of claim 13, wherein at least one of the third hole and the fourth hole is an oblong hole, for example a curved oblong hole, wherein a center distance of the third hole and the fourth hole corresponds with a distance of two holes of the fourth mounting bracket for fastening the fourth mounting bracket to the third mounting bracket.

15. The antenna of claim 13, comprising a second, for example V-shaped, fastening bolt for fastening the fourth mounting bracket to the structure.

16. A method of manufacturing an antenna comprising: providing a reflector, providing a support plate for attaching the reflector to a structure, for example a mounting pole, attaching a housing for a first radio device to the support plate, attaching a first supporting rod to the housing, wherein the first supporting rod is arranged outside of a virtual plane associated with the support plate and is configured to connect the housing to the structure.
